(19) United States
(12) Patent Application Publication
(10) Pub. No.: US 2006/0207772 A1
(43) Pub. Date: Sep. 21, 2006

(54) Structurally supportive horseshoe and method for fitting

(76) Inventor: Gwen Ann Justis, Sebastopol, CA (US)

Correspondence Address: Robin Diane Goldstein, Esquire, 4842 National Avenue, San Jose, CA, 95124-4919, US

(21) Appl. No.: 11/375,550

(22) Filed: Mar. 13, 2006

Related U.S. Application Data
(60) Provisional application No. 60/663,278, filed on Mar. 18, 2005.

(51) Int. Cl. A01L 5/00

(52) U.S. Cl. 168/4

(57) ABSTRACT

A structurally supportive horseshoe comprised of an outer shoe portion and an inner structural stabilizer portion, with the outer shoe being formed from a material that is softer than the structural stabilizer. The outer shoe, one side of which is fitted adjacent to the horse's hoof, and the other side of which comes into contact with the ground, is more insulating than the metal used in a traditional shoe, and helps to maintain the natural temperature of the hoof, while acting as a shock absorber and providing a soft surface upon which the hoof can rest. The structural stabilizer is designed to support each of the structural components of the hoof and foot, including the walls of the hoof, as well as the arch of the foot, while stabilizing the hoof on the ground and in motion, side-to-side, as well as when in the air.

### CROSS-REFERENCE TO RELATED APPLICATIONS

This application claims the benefit of Provisional Patent Application Ser. No. US60/663,278 filed Mar. 18, 2005 by the present inventor.

### STATEMENT REGARDING FEDERALLY SPONSORED RESEARCH

Not Applicable

### REFERENCE TO SEQUENCE LISTING, TABLE OR COMPUTER PROGRAM LISTING

Not Applicable

### BACKGROUND OF THE INVENTION

This invention is directed, in general, to a horseshoe and method for fitting the same, and more particularly, to an improved structurally supportive horseshoe which is designed to support the natural biomechanics of a healthy horse's hoof and which may be used both as a replacement for a traditional flat metal shoe or flat plastic shoe for a healthy horse, or therapeutically in connection with a horse who has suffered disease or injury to the hoof, leg and associated anatomical structures. For the purposes of this invention, the term hoof will be understood to comprise not only the horny sheath that covers the toes, but the foot in general, and when particular reference to the toes, alone, is required, such specification will be made at that time.

As is well understood, a horse's hoof comprises three primary parts: the hoof wall, the sole and the frog. The wall is the visible part of the hoof, which provides a protective wrap around the distal phalanx (also known as P-3, or the coffin bone). The hoof itself may be anatomically divided into (a) the quarters (i.e., the sides); (b) the heel (i.e., the posterior aspect or rear); and (c) the toe (i.e., the anterior aspect or front). The hoof wall is a non-vascularized structure entirely lacking in nerve supply, and it is made from a hard, horny material that is continuously produced, in the manner of fingernails in humans. It must be worn down naturally or trimmed by a farrier with a hoof knife, rasp, or similar tool. In hoof tissues other than the hoof wall, there is a large degree of blood flow, as these are vascularized structures, and only the outer wall of the hoof is not vascularized.

At the heel, the hoof wall is reflected into the hoof interior to form converging ridges known as wall bars. These bars diminish and disappear just prior to approximating in the general center of the heel. The frog is disposed between the bars. It includes an apex pointing anteriorly and a groove, or sulcus bordered by two crura. A collateral sulcus is intermediate to each crus and the bar on each half of the hoof. Proximate the heel, the crura expand to form the bulbs of the heel. The sole is dorsal to the bars and the apex of the frog and is enclosed by the wall of the hoof. The point of convergence of the wall bars and hoof wall is termed the angle of the sole.

Observing a lateral cross-section of the hoof, cartilaginous structures extend back and up from the sides of the coffin bone. These include the deep digital flexor tendon, the navicular impar ligament, and a pair of vertical cartilaginous plates (ungual cartilages). Extending up and back from the navicular bone is the T-ligament, which is connected to both the superficial distal sesamoidian ligament and the deep digital flexor tendon. The superficial digital flexor tendon extends up from the digital cushion, which buffers impact shock imparted to the frog. The navicular bone is positioned between the distal and middle phalanges and above the deep flexor tendon. In a healthy horse, the navicular bursa reduces friction between the navicular bone and the deep flexor tendon. However, in an unhealthy horse, the bursa and the navicular bone may both be involved in navicular disease or navicular syndrome, a common cause of lameness.

Returning to the structure of a horse's hoof, the sole, the frog and its sulci, and the wall bars may each be visualized when the hoof is elevated. In a well-balanced and otherwise healthy foot, the coffin bone is parallel to the ground, medially to laterally, and either parallel to the ground or tipped slightly upwardly (proximally) 3-5 degrees, anteriorly to posteriorly.

A well-balanced foot in an unshod horse will bear weight across the walls, the bars, the sole, and the frog. Since the hoof wall, the sole and the frog are dynamically interrelated structures, when a horse is moving, either walking or running, the sequence in which each component of the hoof contacts the ground is essential to proper structural positioning and dynamics, and also critical to proper circulation within the foot. Biomechanically, the distribution of force through the hoof is as follows: As the horse moves, the frog is the first structure to make contact with the ground. Because the frog is a spongy resilient material, it absorbs some of the initial shock of impact, and thereby buffers the digital cushion. The force of impact causes the frog to flatten so as to push the wall bars apart; at the same time the frog is urged upwardly against the digital cushion, which expands slightly laterally and medially, due to the location and configuration of the ungual cartilages of the phalanx. The resulting compression squeezes the blood vessels in the foot and moves blood from the foot into the leg. When weight is taken off the foot, as the horse continues through its gait, the elastic structures of the foot resume their unloaded configuration, and blood flows back into the foot. This expansion/contraction dynamic of the foot thus provides a kind of pumping effect that stimulates circulation of blood and synovial fluid.

Further observations of a healthy unshod horse, based on the study of wild horses, show that these horses land slightly heel first, enabling the frog to make primary ground contact, as described above. They also reveal that both the heel and the toe of the hoof are slightly rounded, and that the optimal breakover point is radiographically determined to be approximately ¼ inch anterior to the coffin bone, while the weight of the horse is optimally distributed with approximately ⅔ of the weight behind the widest part of the foot and ⅓ ahead between the widest part of the foot and the breakover point.

Although it is not customary to think of a horse's foot as having an arch, and arches are not widely described or discussed in the equine literature or by equine professionals, as a result of the above described observations, the instant invention is founded upon the premise that a horse's foot can be understood to comprise an arch which is generally found to begin at a point proximate the area underneath the tip of the coffin bone, or distal phalanx, extending upwardly through the navicular bone, breaking downwardly, again, through the digital cushion, and ending at a point proximate the frog. This definition is not intended to be limiting, or narrowly construed, but rather may be understood to provide a framework for understanding the complex physical and physiological forces and interactions which take place within and among the elements which make up a horse's foot, and the external environment, such as the ground. For example, the starting and ending, or anchor, points of the arch of the invention are not to be inflexibly defined, but rather to be adjusted according to each individual animal, application and the associated structural support issues desired to be addressed. In addition, the arch may, for some applications, also be understood to additionally comprise the sole of the foot, which, in a complimentary manner, also assists in the structural support of the foot, and will, itself, need to be protected and supported.

Support of this arch, and particularly, of the navicular bone, is critical to equine health. For example, if one imagines the navicular bone to be the keystone of the arch, then the deterioration of this keystone will result in the degradation of the other elements of the foot as well. As a result, for a shod horse to experience the same biomechanical forces as an unshod horse, the horseshoe should augment the natural rolling motion described above, to enable each element of the horse's foot to function properly, and should further support the entire foot, including the arch, in general, and navicular bone, in particular.

Unfortunately, in a traditionally shod horse, the hoof wall generally bears almost all of the weight of the horse because, in traditional shoeing, the hoof wall is the only surface of the hoof to come in contact with the horseshoe that, in turn, touches the ground, with the result that almost all the contact force is transferred through the hoof wall. This is well understood from the observation of a traditional horseshoe shape, a shape so old and familiar it has become iconic, but a shape that treats a horse's hoof as a one-dimensional inanimate object, instead of a live tissue extension of a horse's leg. As a result, relative to wild horses, domesticated horses experience a number of problems, and may thereby suffer, from a number of maladies that are deleterious to their health, and which are due directly to the configuration and application of a traditional horseshoe.

In particular, domestic horses fitted with traditional horseshoes are forced to move flat-footed. In other words, their foot typically lands generally flat, or toe first, rather than slightly heel first, and must, thereafter, take off by lifting the hoof or “toe last”, rather than with a bend at the front of the arch during the “thrust” phase of motion, resulting in the unnatural distribution of force, and a number of associated medical infirmities and/or stress on other body parts to compensate for this unnatural movement.

Second, traditional horseshoes, often, do not allow the frog to touch the ground first, thereby hindering its function in activating the natural hydraulic system built into the hoof, which absorbs impact and which further stimulates circulation within the hoof, maintaining health and soundness.

Third, traditional horseshoes do not allow the hoof to naturally expand upon landing and, particularly at the heel area, do not provide for increased circulation pumping through the hoof.

Finally, traditional horseshoes do not support the arch, as defined above. Instead, the foundation of a horse's structural skeleton, which supports the horse's body, and which is comprised of the sole running underneath the coffin bone, the coffin bone itself, navicular bone, digital cushion, frog and attached tendons and ligaments, is suspended, not supported, by such traditional horseshoes, resulting in faulty biomechanics and unnatural patterns of movement, making domestic horses much more prone to injuries, reduced performance and foot deformities, as well as exposing them to problems of lameness such as navicular.

Attempts have been made to provide a horseshoe that addresses some of the aforenoted limitations, but none have undertaken to successfully address all in a single shoe. By way of example, U.S. Pat. No. 4,605,071 to McKibben is directed to a therapeutic horseshoe adapted for restoring a horse's hoof to a healthy state after the horse has suffered from laminitis, navicular disease or toe-in/toe-out conditions. McKibben discloses a construction having a rigid external impact frame, one side of which contacts the horse's hoof, while the other side contacts the ground, and further incorporates a cushioned insert which forms an enclosed loop around the periphery of the hoof and which is designed to cushion impact to the sole of the foot. However, in addition to a number of limitations observed in the real world use of the McKibben shoe, including a tendency for these shoes to come loose and fall off, McKibben provides no support for the navicular bone and, in fact, recites specifically that in fitting his shoe, the position of the navicular bone should be directly above the middle of the center aperture described by the cushioned insert. As a result, instead of supporting the navicular bone, or the sole, McKibben offers effectively no greater protection than a traditional horseshoe and, in fact, by surrounding the outer rim of the bottom of the foot while leaving the navicular bone unsupported, inadvertently focuses the downward acceleration of each step through the navicular bone, thereby potentially worsening any disease or injury to the foot or surrounding structures.

Another example of a horseshoe that claims to support the natural biomechanics of a horse's hoof is U.S. Pat. No. 6,915,859 to Craig, et al. Craig attempts to address some of the limitations present in McKibben, and further incorporates a projection intended to provide support for the frog. However, like McKibben, Craig leaves the region under the navicular bone unsupported resulting in all of the serious limitations noted above. In addition, McKibben and Craig each teach a composite construction of harder and softer-materials, but in doing so, both also replicate the structural configuration and real-world use of a traditional metal horseshoe where at least a portion of the outer surface is made of the harder material and where the central portion of the shoe is either made of the softer material, or is defined as an open space. As result neither McKibben nor Craig disclose a shoe that provides support for all of the elements of a horse's foot, including the arch, in general, and the navicular bone, in particular.

Accordingly, there is a need for a structurally supportive horseshoe, which can be used as a replacement for an everyday horseshoe, or which can be used as a therapeutic adjunct, and that allows the movement of, and application of forces to, a horse's foot in a manner which closely matches those experienced by an unshod horse, such as a wild horse, and additionally, which supports the arch of a horse's foot, including the coffin bone, navicular bone, digital cushion and frog, and which supports the naturally healthy biomechanics experienced by such unshod horse, resulting in a horseshoe that is structurally supportive of each of the elements of a horse's foot, while overcoming the limitations present in the prior art.

### BRIEF SUMMARY OF THE INVENTION

The invention is directed to a structurally supportive horseshoe configured to support the arch of a horse's foot including the coffin bone, navicular bone, digital cushion and frog, as well as the sole and walls, and a method for fitting the same. The structurally supportive horseshoe is formed in a circular, oval or other shape chosen to match the shape and configuration of the bottom of a particular horse's foot.

The structurally supportive horseshoe is comprised of at least two portions, an outer shoe portion and an inner structural stabilizer portion, with the outer shoe portion being formed from a material that is softer than the structural stabilizer portion. In a preferred embodiment, the outer shoe portion, one side of which is fitted adjacent to the horse's hoof, and the other side of which comes into contact with the ground, is injection molded from a softer thermoplastic such as polyurethane, which is more insulating than the metal used in a traditional shoe, and thereby helps to maintain the natural temperature of the hoof, while acting as a shock absorber and providing a soft surface upon which the hoof can rest. The structural stabilizer portion is formed from a harder thermoplastic, such as a polycarbonate, and is designed to support each of the elements of the arch of the foot, in addition to the heel and walls of the foot, while stabilizing the hoof on the ground and in motion, side-to-side, as well as when in the air. In practice the structural stabilizer is preferably completely located within, and encased by, the outer softer material that makes up the shoe portion.

In one embodiment, the outer portion of the shoe defines a ground-facing surface, a hoof-facing surface, a toe region, a heel region, and a sidewall region. While the entire outer surface of the shoe may form a single solid piece, in a preferred configuration two apertures are defined in the shoe that pass completely from the ground-facing surface through to the hoof-facing surface. These two apertures remove material from the shoe, making it lighter, and further permit air to pass to the surface of the sole of the hoof, aiding in ventilation and enabling medical treatment even while the horse is shod. The two apertures also assist in providing traction and, as they have a plurality of long edges that run lengthwise down the ground facing surface, also prevent the tendency to slide sideways. In practice, these two apertures are located side-by-side and while they pass completely through the outer shoe portion and the structural stabilizer portion, they are separated by a central stabilizer region which runs down the center of both the upper and lower surfaces of the shoe, as well as the middle of the structural stabilizer, which is also not removed, resulting in a pair of openings with the aforenoted benefits as well as a supportive bar that runs underneath the arch.

While the hoof-facing surface of the outer portion of the shoe is preferably smooth, to provide a tight seal and reduce the chance that dirt or grit may make its way between shoe and the hoof leading to an abscess or other irritation, it may also be formed with tracks or channels leading from the opening provided by the aperture to the surface covered by the shoe, in order to permit air to flow more freely in the space between the shoe and the hoof, to permit drainage of a diseased hoof, and to facilitate the application of medicine in a horse with an injured foot.

The ground-facing surface is formed with a tread or cleats, to aid in traction, movement or sliding, and the texture or pattern is chosen depending on the application (racing, stops and starts, therapy, everyday, etc.) as well as the terrain the horse will be moving over. In addition, the toe region of the ground-facing surface is, preferable, not flat, like the hoof-facing surface, but incorporates an incline, either angled or curved, also known as a radius, which is generally configured to start behind the breakover point proximate, generally within ¼″ of the tip of the coffin bone, and continue to an area proximate the tip of the toe, or in an alternate embodiment designed for therapeutic use, to an area set back from the tip of the toe, in order to permit the toe to extend beyond the end of the shoe. The angle, choice of curve, shoe length and exact location of the breakover is determined by the farrier during fitting, in order to provide a pivot point about which the horse may push off during the ‘thrust’ phase of forward motion, similar to the way that a human foot bends at the tip of the arch during movement, although it is anticipated that, generally speaking, an angled configuration will be beneficial in the treatment of founder, while a curved or radius configuration will be preferable for all other applications.

The heel region of the ground-facing surface is also contoured, much like a human running shoe though generally less than the toe region, in order to aid in the fluid heel-to-toe progression of a moving horse, minimizing the “slapping” effect of being forced to move flat-footed and, instead, creating an efficient motion. The configuration of the heel is chosen depending on the application of the shoe, and may be squared, permitting the farrier to shape it according to his or her preference, or in the alternative, comprise a chevron shape which provides side to side stability to the hoof upon landing and converts the downward force of landing into forward momentum, as it absorbs the shock of landing.

The structural stabilizer is positioned within the body of the horseshoe so that when shod, the front most portion of the stabilizer is located slightly behind the tip of the coffin bone with the tip of the coffin bone fitted to the breakover of the shoe, and extends back to a point beneath the vertical axis of the heel bulb, providing support for the entire arch of the foot. The structural stabilizer is, preferably, completely covered on all surfaces by the outer, softer material, and extends across the width of the shoe, and from the heel area to a point behind the breakover point. The structural stabilizer is formed from a material that is harder than the outer shoe portion, preferably a polycarbonate, which permits it to hold the horseshoe nails or screws, which pass through it, in place while supporting the arch. If the horseshoe of the invention incorporates the apertures described above, then those apertures will pass through the structural stabilizer, and the stabilizer will describe the general shape of an I-beam, with a continuous section running across and supporting an area behind the breakover point, a continuous section running underneath and supporting the heel, a continuous section oriented perpendicular and connecting the first two sections, extending down the center of the shoe, supporting the coffin bone, navicular bone, attached ligaments and tendons and two additional continuous sections each also oriented perpendicular to the first two sections, and each also connecting the first two sections proximate an area the edge of either side of the foot.

As each of the thermoplastics which make up the structurally supportive horseshoe are optically clear, in practice a farrier or veterinarian will be able to provide a custom fit by visually aligning the shoe for each particular hoof. During customization the farrier will preferably fit the structurally supportive horseshoe at the heel, first, with the bulbs of the hoof heel located just forward the slope of the heel, and with the breakover of the shoe located proximate the tip of the coffin bone. The farrier will select the proper size and width of the structurally supportive horseshoe to allow for adequate surface area across the heel of the shoe in order to provide full support of the heel as the hoof expands and contracts upon impact. Once properly sized and fitted, the shoe is then nailed, glued or screwed onto the hoof. As noted above, since the materials from which the shoe are formed are optically clear, no pre-defined nail holes are provided but, instead, the farrier properly places the shoe as described above, noting the white line around the bottom of the hoof, the apex of the frog and the location of the tip of the coffin bone, and then marks the shoe to indicate where the holes should be made. The holes may be made in any usual fashion, typically with a punch or drill, and are preferably countersunk through the polyurethane to the harder polycarbonate structural stabilizer, which is hard enough to hold the nail in place, and which prevents wear of the shoe to result in the horse “walking on nails”.

Accordingly, it is an object of the invention to provide an improved horseshoe that is structurally supportive of each of the elements of a horse's foot.

It is another object of the invention to provide an improved horseshoe that distributes force of impacting the ground across a horse's foot in a manner similar to those experienced by a wild unshod horse.

It is a further object of the invention to provide an improved horseshoe that supports the arch of a horse's foot, such arch defined by the coffin bone, the navicular bone, the digital cushion and the frog, and the sole running underneath.

It is an additional object of the invention to provide an improved horseshoe that provides thermal insulation from the ground.

It is yet another object of the invention to provide an improved horseshoe in which an outer softer material which comes in contact with both the ground and a horse's foot surrounds an inner harder material which functions as a structural stabilizer.

It is yet a further object of the invention to provide an improved horseshoe in which different tread patterns may be molded into the surface which comes in contact with the ground in order customize the shoe for use in different terrains, different activities such as quick stops and starts, and still further to provide on such surface a plurality of apertures formed with edges running perpendicular to the tread in order to enhance traction and to prevent sliding sideways, or to enhance sliding forward but not side to side, depending on the horse's activity.

It is yet an additional object of the invention to provide an improved horseshoe where the front area of the shoe is formed with an incline extending from behind the breakover to the toe and the rear area of the shoe is formed with an angle proximate the heel so as assist in the movement of a horse by employing the force and momentum of a moving horse to propel it forward.

It is still another object of the invention to provide an improved horseshoe, with structural stabilization and support for the arch of a horse's foot, which may optimized for everyday use, for use in racing, for use in a therapeutic mode, or for use in a boot configuration.

It is still an additional object of the invention to provide an improved horseshoe that may be formed optically clear, so as to facilitate fitting, or may be formed in colors or with embedded sensors or electronics, and then fitted using a clear template.

Still other objects and advantages of the invention will in part be obvious and will in part be apparent from the specification.

The invention accordingly comprises the features of construction, combinations of elements, and arrangements of parts, which will be exemplified in the constructions hereinafter set forth, and the scope of the invention will be indicated in the claims.

### BRIEF DESCRIPTIONS OF THE SEVERAL VIEWS OF THE DRAWINGS

For a fuller understanding of the invention, reference is had to the following descriptions taken in connection with the accompanying drawings, in which:

FIG. 1 is a bottom perspective view, showing the ground-facing side, of a first preferred embodiment of the structurally supportive horseshoe of the present invention, such first preferred embodiment comprising a straight heel and full cutouts;

FIG. 2 is a bottom plan view of the first preferred embodiment as illustrated in FIG. 1;

FIG. 3 is a top plan view of the first preferred embodiment as illustrated in FIG. 1;

FIG. 4 is a side view in elevation of the first preferred embodiment with an angled toe as illustrated in FIG. 1;

FIG. 5 is a bottom plan view of a second preferred embodiment of the structurally supportive horseshoe of the present invention, such second preferred embodiment comprising an angled chevron at the heel portion and a planar top surface with only partial cutouts;

FIG. 6 is a front elevation view of the second preferred as illustrated in FIG. 5;

FIG. 7 is a side elevation view of the second preferred embodiment with a radius toe as illustrated in FIG. 5;

FIG. 8 is a bottom perspective view of the second preferred embodiment as illustrated in FIG. 5;

FIG. 9 is a top plan view of a third preferred embodiment of the structurally supportive horseshoe of the present invention, such third preferred embodiment comprising a smooth, continuous hoof-facing surface;

FIG. 10 is a front elevation view of the third preferred embodiment as illustrated in FIG. 9.;

FIG. 11 is a side elevation view of the third preferred embodiment as illustrated in FIG. 9;

FIG. 12 is a top perspective view of the third preferred embodiment as illustrated in FIG. 9;

FIG. 13 is a bottom plan view of a fourth preferred embodiment of the structurally supportive horseshoe of the present invention, such fourth preferred embodiment comprising a short toe portion and full cutouts;

FIG. 14 is a top plan view of the fourth preferred embodiment as illustrated in FIG. 13;

FIG. 15 is a front elevation view of the fourth preferred embodiment as illustrated in FIG. 13;

FIG. 16 is a side elevation view of the fourth preferred embodiment as illustrated in FIG. 13;

FIG. 17 is a bottom plan view of a fifth preferred embodiment of the structurally supportive horseshoe of the present invention, such fifth preferred embodiment adapted for use as a racing shoe;

FIG. 18 is a front elevation view of the fifth preferred embodiment as illustrated in FIG. 17;

FIG. 19 is a side elevation view of the fifth-preferred embodiment as illustrated in FIG. 17;

FIG. 20 is a bottom perspective view of the fifth preferred embodiment as illustrated in FIG. 17;

FIG. 21 is an upper rear perspective view of one embodiment of the structural stabilizer of the present invention;

FIG. 22 is top plan view of one embodiment of the structural stabilizer of the present invention;

FIG. 23 is a rear view in elevation of one embodiment of the structural stabilizer of the present invention;

FIG. 24 is a side view in elevation of one embodiment of the structural stabilizer of the present invention;

FIG. 25 is a perspective view of one embodiment of the structurally supportive horseshoe of the present invention illustrating the structural stabilizer showing as embodied in an all-purpose shoe having a short toe radius;

FIG. 26 is a side elevation view of the embodiment of the invention with a radius toe as illustrated in FIG. 25;

FIG. 27 is a side elevation view of an embodiment of the invention illustrating the position of the structural stabilizer within an angled toe shoe;

FIG. 28 is a top plan view of a second embodiment of the structural stabilizer of the present invention;

FIG. 29 is a side view of a second embodiment of the structural stabilizer of the present invention;

FIG. 30 is a front elevation view of a second embodiment of the structural stabilizer of the present invention;

FIG. 31 is a perspective view of a second embodiment of the structural stabilizer of the present invention;

FIG. 32 is a side view of an embodiment of the structurally supportive horseshoe of the present invention adapted for use as a racing shoe and further comprising the second embodiment of the structural stabilizer of the present invention;

FIG. 33 is a side elevation view of a template accessory constructed in accordance with the teachings of the instant invention;

FIG. 34 is a top plan view of a template accessory constructed in accordance with the teachings of the instant invention; and

FIG. 35 is a perspective view of a boot configuration of a horseshoe constructed in accordance with the teachings of the instant invention.

### DETAILED DESCRIPTION OF THE INVENTION

In the detailed descriptions of the preferred embodiments of the invention that follow, like reference numerals refer to like components in the various views, in which there is illustrated several embodiments of a new and improved structurally supportive horseshoe.

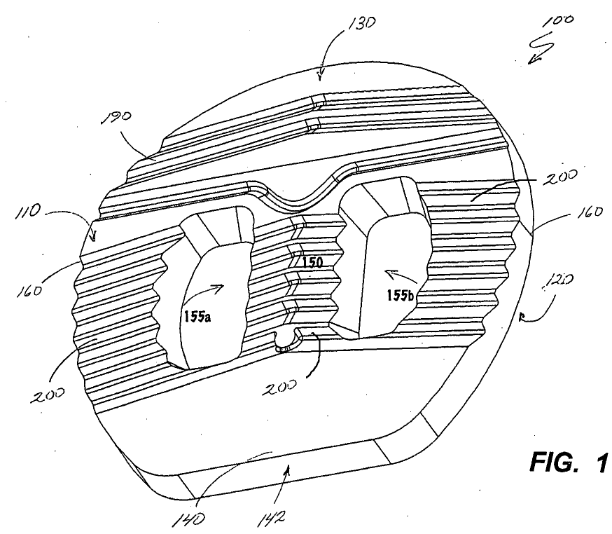

Referring to FIGS. 1-4, the outer shoe portion of a first preferred embodiment of the structurally supportive horseshoe of the instant invention, generally indicated as 100, is shown. In this first preferred embodiment, a general purpose shoe incorporating a square heel, the inventive horseshoe comprises a ground-facing surface 110, a hoof-facing surface 120, a toe region 130, a heel region 140, a center region 150, and a sidewall 160 which extends around the entire periphery of structurally supportive horseshoe 100 and couples the ground-facing surface 110 to the hoof-facing surface 120 at a distance dependant on the size and style of the shoe. The overall outer shape of the structurally supportive horseshoe 100 approximates the shape of the bottom of a horse's foot, with the actual dimensions chosen, and modified as necessary by a farrier or veterinarian, in order to provide a custom fit for each horse and each foot. The outer shoe portion 100 is preferably formed from a softer thermoplastic, such as polyurethane, which may be easily shaped by a farrier, and which acts as a shock absorber, provides a soft, comfortable and cushioned surface for a horse's hoof to rest on, and aids in traction. The use of an insulating material, as opposed to a conductive material such as metal, also helps to maintain body temperature, and helps to prevent the discomfort of moving on a very cold surface with metal shoes.

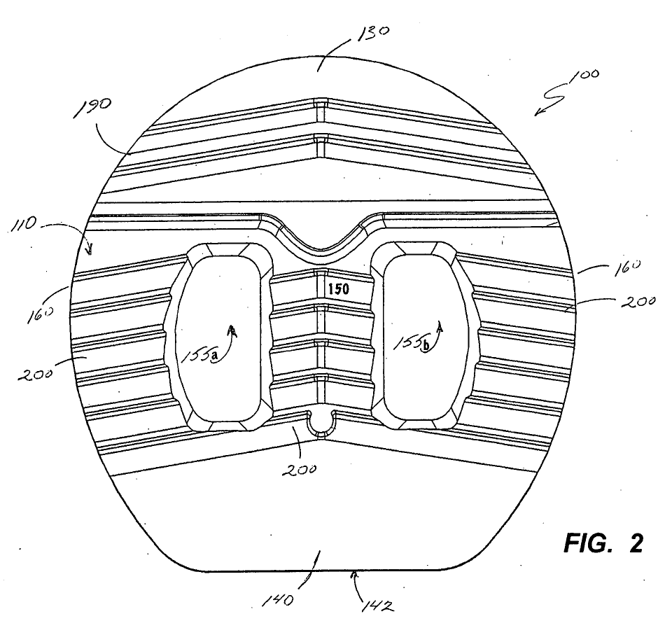

Continuing an examination of the ground-facing surface 110 as illustrated in FIG. 1 and FIG. 2, it can be seen that this surface comprises a number of features including tread, cleats, or other surface contours intended to improve traction on different terrains. In the first preferred embodiment of structurally supportive horseshoe 100, toe region cleats 190 and center region cleats 200 are included and angled with a bias so that they will experience the greatest grip against the ground when a foot shod with the shoe of the invention moves in a forward direction. They can also be formed without an angular bias, with equal surface area on either side of the cleat, so that equal traction is provided to movement in either a forward or backward direction. In practice the angle, bias and depth of the cleats will vary according to need, but in general the cleats will have an angle ranging from 25 degrees to 80 degrees measured from a flat surface plane, and may be located across the entire ground-facing surface; across the toe region, each side of the shoe and down the middle; or only down the sides and the middle of the shoe. In addition, while the exact configuration of cleats is highly flexible, it is preferable that cleats be provided proximate the toe region of every shoe, and in the area proximate the breakover of the shoe, a feature described in detail below. It is also noted that, as stated above, the placement and arrangement of cleats or treads will depend on the actual application of the shoe. By way of example, racing shoe toe cleats are generally spaced farther apart than the cleats on more general purpose models in order to allow a racing shoe “grab”, also discussed further within, to protrude through the surface of the shoe. Nevertheless, it is generally understood that in most applications the distance between cleats will range from 0.1704 to 0.9844 inches.

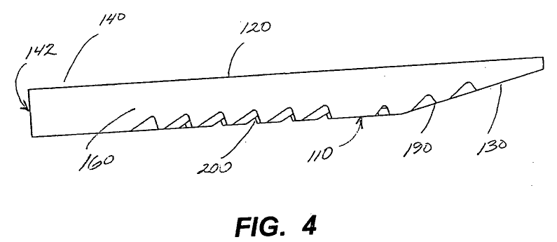

An additional feature of the invention can be seen in FIG. 4, FIG. 7, FIG. 11 and FIG. 16, among others. As illustrated, in a preferred embodiment, the ground-facing surface of the horseshoe does not describe a flat linear plane, but rather comprises an incline, either straight 420 as illustrated by way of example in FIG. 11, otherwise known as an ‘angled toe’, or curved, 425 as illustrated by way of example in FIG. 16, otherwise known as a ‘radius toe’, with such incline starting behind the breakover, generally defined as a line, running side to side, and located proximately behind the tip of the coffin bone, when the shoe fit and attached, and continuing through to the tip of the toe region. Either toe variation may be utilized with each alternative, embodiment of the invention, and although the actual specifications for each toe type will depend on the size of the shoe and desired result, as a starting point it is recommended that the angled toe have a minuscule radius of 0.5000 inches at the point of the angle, with an angle ranging between 14 degrees and 16.23 degrees, while the radius toe will define a longer slope with the radius ranging between 0.500 inches and 3.188 inches.

The purpose of the incline of either the angled toe or radius toe is to facilitate a more natural rolling motion, as opposed to a slapping motion, when the horse is moving, by providing the functional equivalent of a pivot point at what might analogously be thought of as the ball of the foot. In practice the incorporation of an incline means that the toe region 130 of the shoe 100 begins to angle upwardly, towards the hoof and away from the ground, at a point located near the breakover of the horse's hoof, with this point being identified by the farrier during the installation process. This tapering up of the toe allows the hoof to bend at the proper breakover position and, as described above, to push off during the “thrust” phase of forward motion, much the way a human foot bends at the toe or tip of the arch to move forward. Further, as a result of utilizing angled or radius toe, the tip of the toe region of the shoe is thinner than the central region.

In addition to the incline, it is also noted that while the ground-facing surface 110 may be solid and continuous, it is another feature of the invention that two apertures 155a and 155b may be defined in the shoe 100 and, in one preferred embodiment, these apertures may pass completely from the ground-facing surface 110 through to the hoof-facing surface 120. The two apertures serve a number of purposes, including the removal of excess material from the shoe, thereby making it lighter, and providing a plurality of edges running perpendicular to the cleats, enhancing traction and resisting any sliding movement sideways. These two apertures, when passing completely through the shoe, also assist in permitting air to pass to the surface of the sole of the hoof, aiding in ventilation, permitting draining or allowing for the introduction of a cushioning material, such as Equithane® or 2-ply silicon, thereby enabling medical treatment even while the horse is shod. In practice, the two apertures 155a and 155b are preferably located side-by-side and while they may pass completely through both the outer surface of the shoe and an inner structural stabilizer portion, the construction of which will be discussed in more detail below, they are separated by a central stabilizer region 150 which runs down the center of both the upper and lower surfaces of the shoe, as well as the middle of the structural stabilizer. This aperture configuration balances the access requirements for anyone caring for a horse, with the need for the structural support to the arch, as provided by the invention, and results in a pair of openings that provide the aforenoted benefits while maintaining the integrity of the structurally supportive construction of the shoe.

Completing the elements of the ground-facing surface 110 is a heel region 140, which, in the first preferred embodiment, defines a substantially straight back edge 142 and has a thickness substantially identical to the thickness of the central region of the shoe. By utilizing such a square heel the farrier is given the greatest flexibility in custom shaping the shoe heel to the horse and each foot.

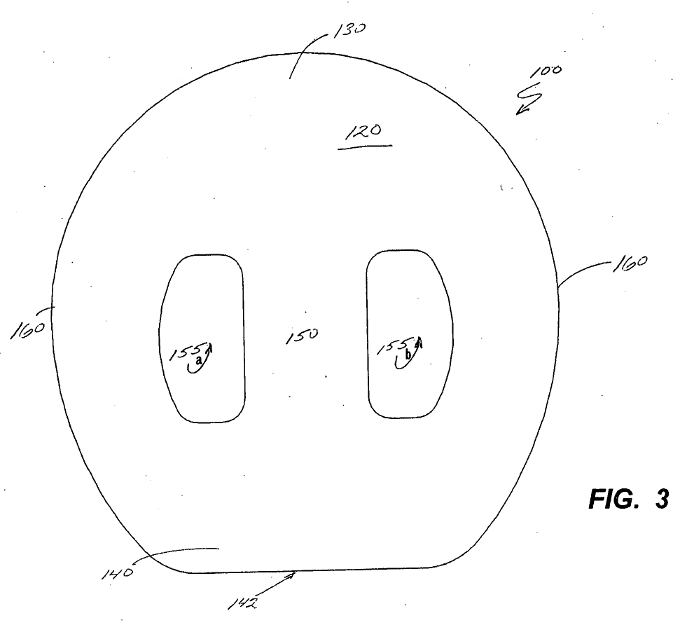

Turning next to FIG. 3, the hoof-facing surface, generally 120, of the horseshoe 100 of the instant invention is shown. As illustrated in this embodiment, the hoof-facing surface is effectively flat, without angles, in order to provide a consistent, smooth surface against the horse's foot upon which the sole of the hoof rests during the impact and stance phase of forward motion. By employing a large surface area covering, for example, more than 75% of the space directly beneath the foot, this configuration also provides for the uniform dispersal of concussion and impact forces experienced by the sole of the hoof. In addition, as can be seen, other than the first and second apertures, 155a and 155b, which extend through from the ground-facing surface, the hoof-facing surface 120 is featureless in order to ensure a tight fit against the bottom of the horse's hoof when nailed or otherwise attached.

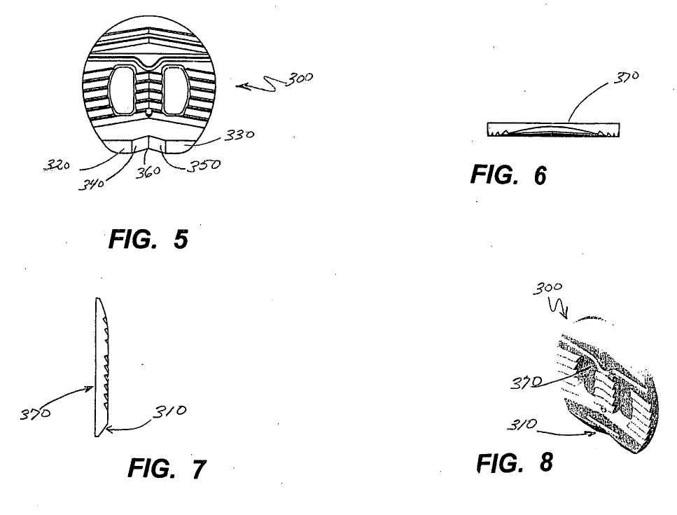

Continuing on to FIGS. 5-8, a second preferred embodiment 300 of the instant invention is shown. The characteristics and features of this embodiment are identical to those of the first preferred embodiment of the structurally supportive horseshoe 100, with the exception that the heel portion of embodiment illustrated in FIGS. 5-8 does not define a substantially straight back edge with a thickness substantially identical to the thickness of the central region of the shoe, but instead defines an angled chevron 310. The chevron comprises two outboard planar slopes 320 and 330, and two inboard slopes 340 and 350, which converge at the longitudinal axis of the shoe to form a notch 360. The use of the chevron heel 310 results in a number of benefits including providing side-to-side stability to the hoof upon landing and the absorption of the shock and impact of landing during the heel-to-toe strike path. The chevron heel 310 also converts the downward force of landing into forward momentum, and allows an even dispersal of the concussion of impact, which in turn, prevents hoof vibration. Finally, the chevron heel 310 is designed to simulate the feel of a rounded hoof found in wild horses and, therefore, to encourage proper biomechanics during use. Although shown in connection with the embodiment illustrated in FIGS. 5-8, a chevron heel may be incorporated in connection with any practice of the instant invention. In addition, although the angles which form the chevron may be chosen in accordance with the horse, surface, etc., in general it is recommended as a starting point that looking at the shoes sideways, the angle of the chevron to the ground ranges between 35 degrees and 39 degrees; looking at the chevron heel, facing the ground-side of the shoes, the included angles will range from 165.02 degrees to 167.8 degrees; looking at the chevron heel, facing the ground-side of the shoe, the angles opposite the included angles will range between 12.2 degrees and 14.98 degrees; and the fillet angles on the sides of the chevron heel will range from 0.750 to 0.875 degrees.

FIGS. 5-8 also show an alternative to the fully open first and second apertures of the horseshoe 100 shown in FIGS. 1-4. In this embodiment each of the apertures pass through the ground-facing surface and the structural stabilizer, but do not pass through the hoof-facing surface 370 of the second preferred embodiment 300. As a result of this construction, the apertures may continue to assist in traction and stability while the hoof-facing surface is rendered substantially planar and thus is not open and does not expose the bottom of the horse's hoof to the air. This aids in preventing extraneous material, such as dirt or small stones or other liquids or debris from enter the space between the hoof and the shoe, reducing the possible introduction of irritants and the resulting inflammation and potential infection or abscessing. While illustrated in connection with the embodiment shown in FIGS. 5-8, this configuration of the first and second apertures may be employed with any of the preferred embodiments taught by the invention and is therefore not characteristic of any one of them, but potentially of each and all of them.

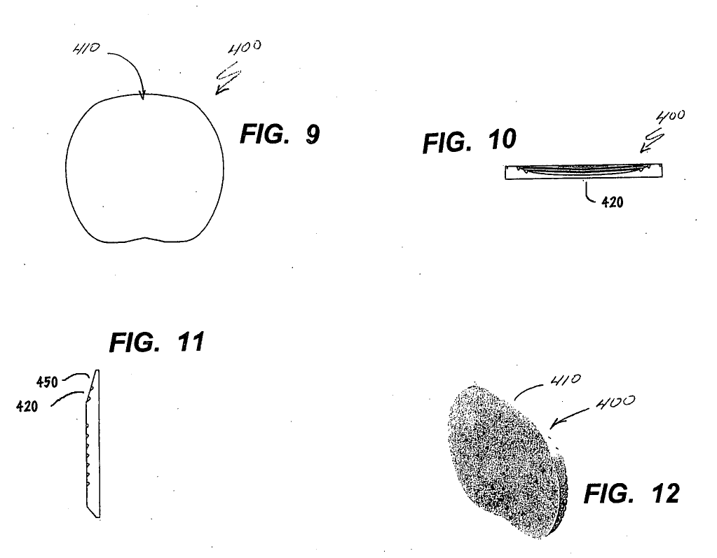

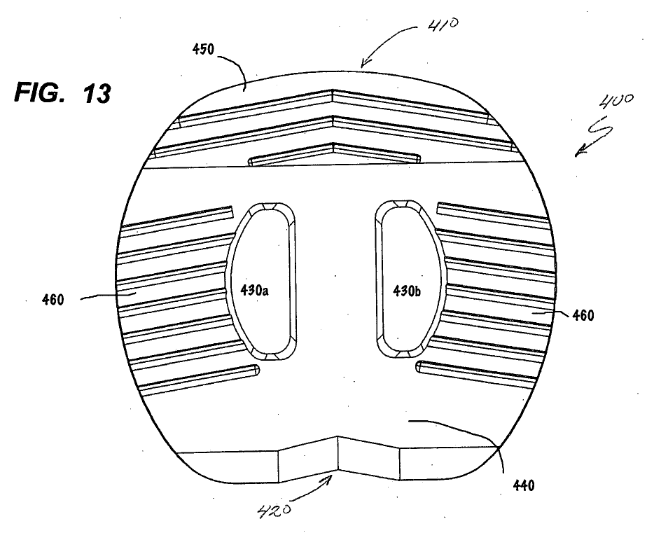

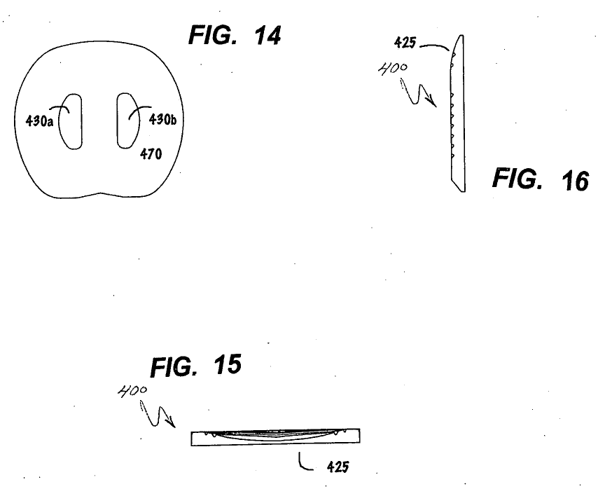

Turning next to FIGS. 9-16 a third preferred embodiment 400 comprising a number of variations of the elements of the present invention is shown. As can be seen, this embodiment comprises a short toe 410 with either an angled toe 420 configuration, as illustrated in FIGS. 10 and 11, or a radius toe 425 configuration as illustrated in FIGS. 15 and 16. This short toe design contrasts with the full toe configuration utilized in the first and second embodiments, and it is expected that variations of the invention comprising such short toe configuration may be particularly useful in therapeutic applications, although such a short toe design can also be used in performance and pleasure applications. One of the benefits of the short toe variation is that the horse's hoof extends beyond the tip of the shoe, making it easily accessible to a veterinarian or other for treatment of injury or disease. In addition, by utilizing a short toe shoe, the exposed toe of the horse's hoof can be rockered with a rasp to facilitate the thrust motion of the stride. This embodiment may be provided with a straight back edge 142, as in FIGS. 1-4, or with a sloping chevron heel 310, as described above in relation to FIGS. 5-8. In this model, as all models, the incline from the breakover may also be provided in either an angled toe 420 configuration, as illustrated in FIG. 11 or with a radius toe 425 configuration, as illustrated in FIG. 16. Furthermore, as shown in FIGS. 9 and 12, the shoe may be provided with covered cutouts that seal the hoof bottom from ground, air, and possible injury or insult, or as illustrated in FIG. 14, may comprise apertures 430a and 430b that pass completely through ground-facing surface 470 of the shoe. Finally, it is observed that configurations employing the short toe radius will generally experience less traction, by reducing the available area on the ground-facing surface for tread, which may be preferable in certain applications. In addition, as can be seen in FIG. 13, this configuration may provide even less traction, by eliminating the treads from the central stabilizer region 440, and confining them to the toe region and outer stabilizer regions.

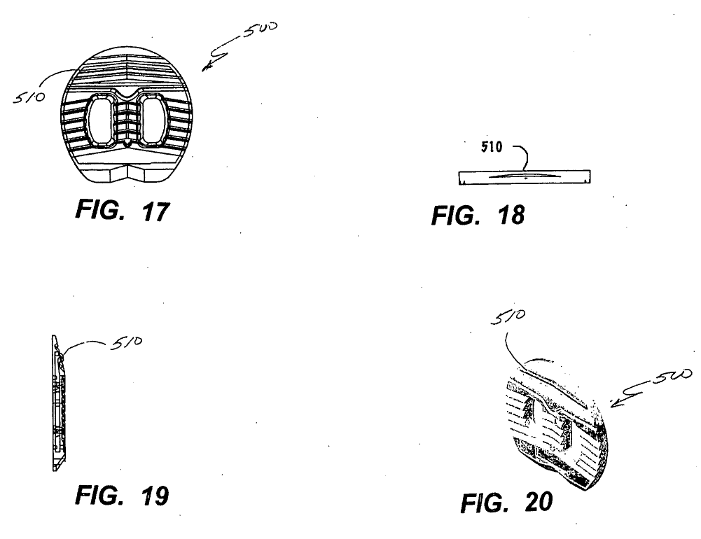

Referring next to FIGS. 17-20 a fourth preferred embodiment 500 of the structurally supportive horseshoe of the instant invention is shown. This embodiment is particularly adapted for use as a racing shoe, and further comprises a shoe grab 510, formed from a hard material such as polycarbonate, that distinguishes this embodiment from the previous embodiments. Except for the shoe grab 510, which is, in the preferred embodiment, integral with the structural support member, described in the following paragraphs, a shoe optimized for racing in accordance with the instant invention may be designed with any of the aforenoted variations, including an angled toe or radius toe, an angled heel or a square heel, and the like.

Considering the foregoing examples, in a typical application, it is generally anticipated that the same type of shoe will be fitted to all four feet. However, this is not a requirement of the invention, and differing embodiments of the structurally supportive horseshoe may be fitted at the same time on different feet, depending on the intended result or treatment desired by a farrier or veterinarian. In addition, further variations of tread design, not illustrated, are available for use with the invention. By way of example, in some sporting activities that make use of horses, it is necessary for these horses to run and then tuck their hind legs underneath their body and come to a sliding stop. Traditionally, “sliders”, a slick type of conventional horseshoe, are fitted on the hind feet to facilitate this sliding motion, and it is understood that for this type of activity the teachings of the instant invention may be applied to the front feet, while conventional slider shoes are applied to the rear or, in the alternative, a variation of the instant invention may be used on the hind legs which comprises the structurally supportive elements while further incorporating either a slick or specialized tread pattern. It is also anticipated that the tread design may be modified to comprise studs or calks, over at least a portion of the ground-facing surface, to increase the effectiveness of the shoe of the invention for use in snow or mud or other soft ground surfaces,

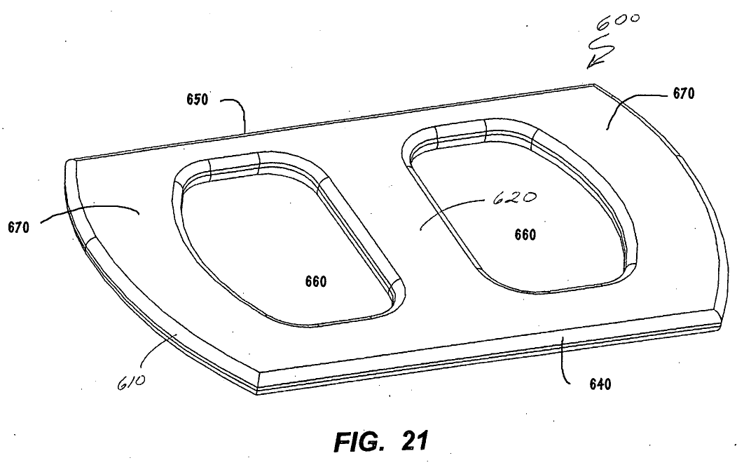

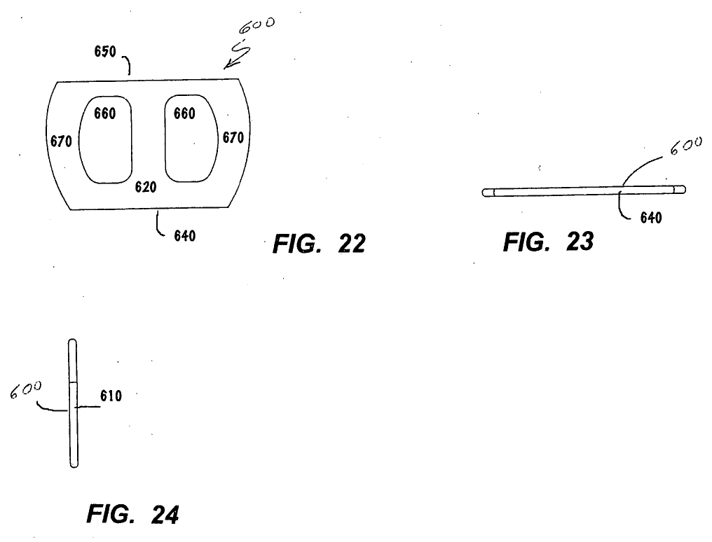

Turning next to FIGS. 21-24, an example of a structural stabilizer constructed in accordance with the instant invention is shown. In order to understand the function of the structural stabilizer, it is helpful to recognize that while a well-balanced foot in an unshod horse will bear weight across the walls, the bars, the sole, and the frog, traditional metal and other modern metal and plastic horseshoes may support the walls or the frog, but do not support each of the elements of the foot at the same time. In addition, although it is not customary to think about a horse's foot as having an arch, the instant invention is based upon the recognition that a horse's foot can, indeed, be modeled as comprising an arch which may be visualized as beginning at the tip of the coffin bone, or distal phalanx, extending upwardly through the navicular bone, breaking downwardly, again, through the digital cushion, and ending at the frog, and may further comprise the sole beneath these structures. Support of this arch, and particularly, of both the navicular bone and coffin bone, is critical to equine health. For example, if one imagines the navicular bone to be the keystone of the arch, then the deterioration of this keystone will result in the degradation of the other elements of the foot as well. One can also understand that that rotation of the coffin bone, which is seen in founder, will destroy the structural integrity of the arch, as it shifts and weakens one of the arch's anchor points. As a result, for a shod horse to experience the same biomechanical forces in the same way as they are experienced as an unshod horse, in addition to augmenting the natural rolling motion through the use of enhanced heel and toe regions, as described in the features of the invention disclosed above, a structurally supportive horseshoe should also provide structural support for each of the elements of the foot, including the arch, in general, and navicular bone and coffin bone, in particular.

Accordingly, referring to FIGS. 21-24, an implementation of a structural stabilizing 600, formed in accordance with the teachings of the present invention, is shown in a state prior to being incorporated into a finished horseshoe. As can be seen, the structural stabilizer is formed of a substantially planar panel and is preferably fashioned of polycarbonate or similar material that may resist bending or twisting forces, and functions to support the coffin bone of the hoof, anterior to posterior, and the whole hoof, side to side, including the walls of the hoof, and further functions to stabilize the hoof during the stance phase of motion, thrust phase of motion, as it prepares to land, and while in the air during gait.

Although various construction techniques may be used, in a preferred embodiment the structural stabilizer 600 is molded into, and completely encased by, the outer shoe portion of a horseshoe constructed in accordance with the invention. The structural stabilizer 600 is generally sized and shaped for each particular shoe so that after manufacture, the stabilizer will generally span the width of the shoe from edge to edge, and extend from the heel to a point behind the breakover along the length. Because the structural stabilizer must both accommodate and cooperate with the apertures of the outer shoe portion, which in some embodiments will pass completely through surface of the stabilizer, shown as stabilizer apertures 660, in a minimum configuration the stabilizer will run at least along both sides of the central region 670, and down the midsection 620 of the shoe and the stabilizer from the breakover to the heel. In practice, the outer edges 610 of the structural stabilizer 600 may be rounded or squared off, with the rounded edges, while potentially more difficult to fabricate, allowing the insert to adhere more effectively to the exterior polyurethane material during and after the manufacturing process.

As noted above, in accordance with the teaching of the invention, once embedded in a finished horseshoe, the structural stabilizer supports the internal structure, or arch, of the hoof (coffin bone, navicular bone and middle phalanx and digital cushion), as well as supporting the frog and the hoof walls, and stabilizing movement of the hoof on the ground and while in the air, mid stride.

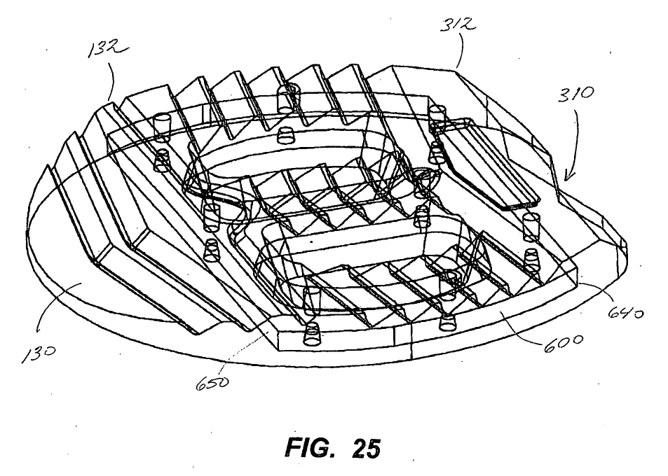

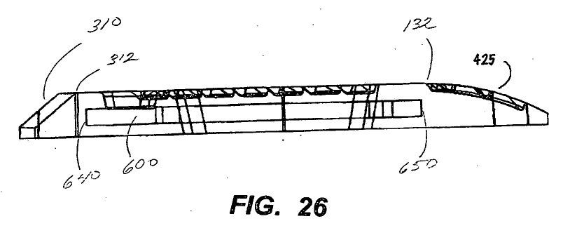

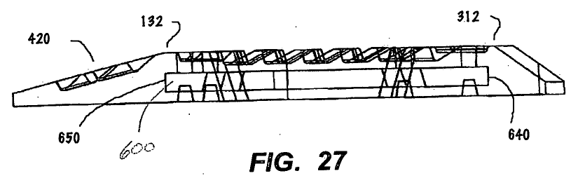

FIG. 25 is a perspective view showing the structural stabilizer 600 as installed in the second preferred embodiment of the inventive horseshoe, while FIG. 26 presents a side view in elevation showing the position of the structural stabilizer 600 in an all purpose shoe having a chevron heel and FIG. 27 provides a side view in elevation showing the position of the structural stabilizer 600 in an angled toe shoe. Each of these views show that the back edge 640 of the structural stabilizer is proximate the point 312 at which the angled heel angles from the ground-facing side of the shoe, while the front edge 650 is proximate the point 132 at which the toe portion begins angling away from the ground-facing surface.

In addition to providing structural support for the foot and arch, another advantage of utilizing the structural stabilizer is that it may function as an anchor for horseshoe nails, studs, calks, or other ground-facing surface treatments. As is well known in the art, a significant problem with horseshoes formed from polymers is that softer plastics do not have enough strength to hold horseshoe nails in place. As a result, plastic horseshoes are known to become loose and, occasionally, even fall off. In some cases glues may be used instead of nails, but the use of adhesives creates a different class of problems, including increasing the difficulty of keeping shoes attached to the foot, as well as changing and applying shoes quickly. The instant invention addresses these problems, and permits maintaining the advantage of using a softer outer plastic, by encompassing the stronger, stiffer structural stabilizer. In a preferred configuration, the farrier will locate the horseshoe nails so that they pass through both the outer shoe surface and the inner structural stabilizer. The nail holes may be countersunk so that the nail head sits deeper within the shoe, and avoids direct contact with the ground, and the ‘walking on nails’ effect, however the nail is held firmly in place as it passes through the structural stabilizer.

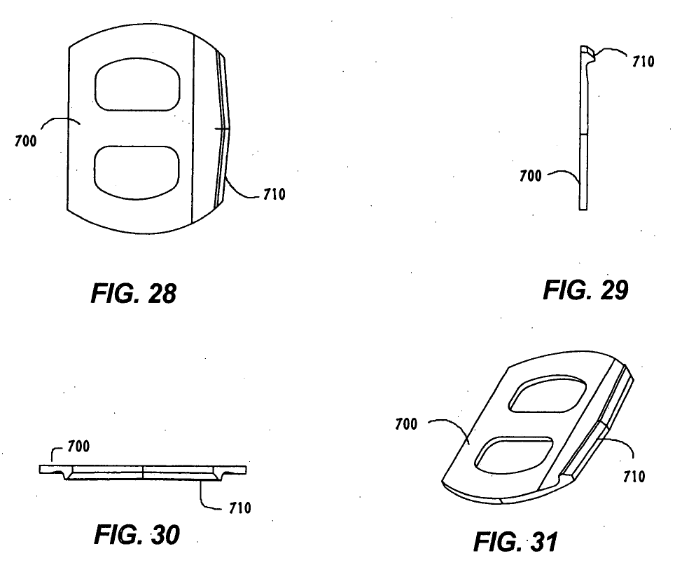

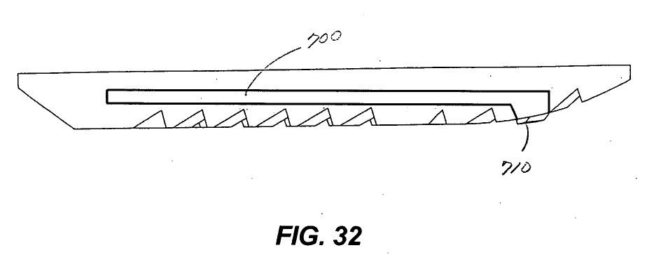

Finally, while as described above the structural stabilizer is preferably fully encased by the outer shoe surface in most applications, a fifth embodiment of a horseshoe constructed in accordance with the instant invention, and especially adapted for racing, permits and takes advantage of a modification to this encasement by allowing a portion of the harder structural stabilizer material to extend through the softer outer shoe material along a portion of the ground-facing surface, with the resulting exposed portion acting as a shoe grab. Referring to FIGS. 28-31, a structural stabilizer 700 comprising a grab 710, as describe above, is shown. A side view of a horseshoe comprising such a shoe grab is illustrated in FIG. 32 which shows the structural stabilizer 700 in a racing shoe and the extra toe cleat, or shoe grab 710, formed from the hard structural stabilizer material, extending through the ground facing surface of the shoe.

Accordingly, by constructing a horseshoe in accordance with the teachings and embodiments described above, an improved horseshoe can be realized that is structurally supportive of each of the elements of a horse's foot, which distributes the forces of impact across a horse's foot in a manner similar to that thought to be experienced by wild, unshod horses, and which, in particular, provides support to the arch of a horse's foot, with such arch being defined by the coffin bone, the navicular bone, the digital cushion and the frog, and which arch may further comprise the sole beneath these structures.

In addition, while a number of preferred embodiments are disclosed, variations on each element, as well as the mixing of elements between different embodiments, may be had to some additional advantage. By way of example, each embodiment may be formed as a horseshoe, a boot or as a template accessory. By way of additional example, every shoe may be fitted with either an angled toe region or a radius, or curved, toe region. In addition to the foregoing, a number of other variations are described immediately below.

First, as disclosed, the described embodiments of the structurally supportive horseshoe are formed in several steps. In general, the structural stabilizer element is first fabricated from a polycarbonate material. A mold of a finished shoe, with such mold comprising the selected ground-facing surface features, location and shape of the apertures, and hoof-facing surface features, is then made and the structural stabilizer is located within said shoe mold. Finally a softer plastic, such as polyurethane, is injection molded around the structural stabilizer. In practice the two materials are chosen with characteristics that permit them to tightly bond to one another. This material bond allows the farrier to customize the shoe for an individual horse's hoof, and to tailor the shape of the outer edge of the shoe to fit without the edge of the shoe becoming structurally compromised. The bond between the two materials also prevents dirt or other foreign matter from becoming interposed between the layers of the shoe after it has been shaped. In addition, as a result of this injection molding process, the hoof-facing surface of the shoe may be forced into a slightly concave shape, with each of the outer edges being slightly curved relative to the apertures, and this slight curvature helps to permit the shoe to be fit and held snugly against the horse's hoof once the shoe has been nailed or glued in place.

As is understood, the process described above anticipates the use of two distinctive polymers to form the shoe. However, it is also recognized that other combinations of materials may be used, including for example, forming the structural stabilizer out of a lightweight but rigid metal, such as titanium or carbon fiber steel, as long as the structural stabilizer component exhibits the necessary rigidity to provide support for the arch and foot elements described above. It is also possible to form the outer shoe from metal or other non-polymer material, which may decrease its thermal insulation properties, but may provide other application specific benefits. It is additionally possible to form the outer shoe from a plurality of materials, for example, using different materials for the hoof facing surface and the ground facing surface so that, in one case, thermal insulation and comfort is provided against the sole of the foot while the benefits of a non-polymer material may be obtained for the ground-facing surface. In addition, it is further anticipated that a shoe may be designed from a single material, and potentially as a single solid member, having the structural integrity necessary to the structural stabilizer, with a pad or other soft plastic or alternative material interposed between the shoe and the bottom of the foot. In these configurations a template might also be necessary, even if the shoe is optically transparent, since it may not always be possible to see the bottom of the foot through the external padding material.

Continuing with a discussion of the materials selected to form each of the components of the structurally supportive horseshoe of the instant invention, in a preferred embodiment both the outer shoe material and the structural stabilizer material are each chosen not only for their physical characteristics, but also for their optical properties. In particular, it is an advantage of the instant invention that by utilizing optical clear materials, no pre-defined or pre-drilled nail holes are provided or defined, or even necessary, but instead, the farrier or veterinarian may actually observe through the horseshoe and structural stabilizer, the frog, white line, and other anatomical features of the foot, and then mark and drill holes through the shoe, and the structural stabilizer, accordingly.

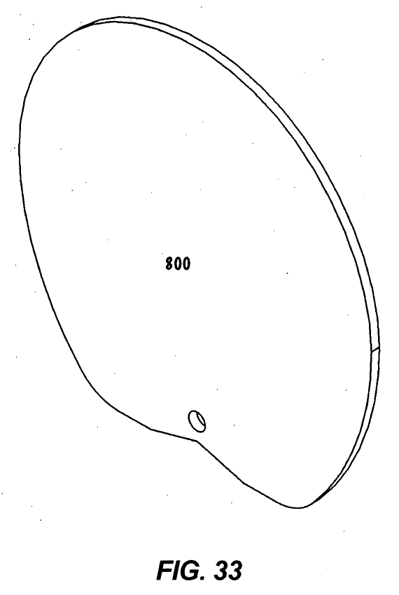

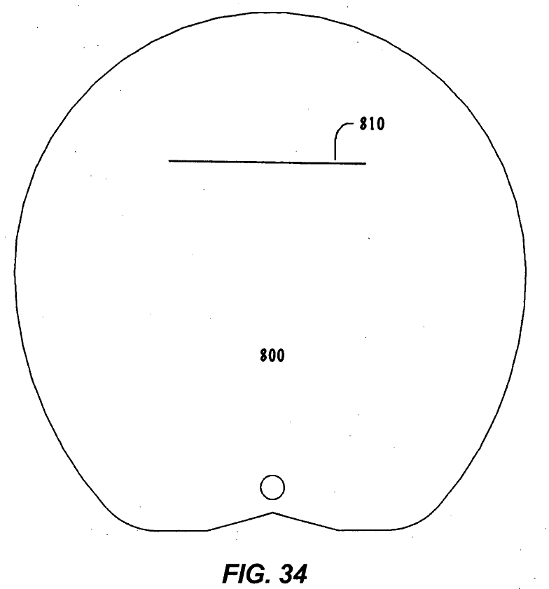

In the alternative, it may be desirable for fashion, design, or other purposes or special events, to form one or more of the components of the shoe using colored plastics or other materials, as described above, that may not be optically clear. In such case, a transparent template of the actual shoe is formed in connection with the manufacturing process with the template having the same dimensions as the actual shoe, except for thickness, including the shape, size and configuration of the perimeter as well as the arrangement of the apertures. An example of such a template 800 is illustrated in FIGS. 33 and 34. The template may have a line, mark or other indicator 810 identifying where the breakover in the shoe is located in order to assist in proper fitting, and the farrier will use the template to determine the optimal placement for the nail holes, and mark accordingly. The farrier may then use the marked template to prepare the actual shoe, in a process described in more detail below.

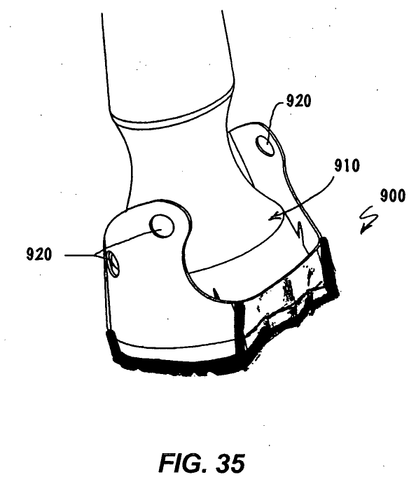

In addition, the template can also be used in connection with the adaptation of the invention to a boot design, which comprises all of the features of the shoe in addition to covering at least a portion of the end of the leg or a portion of the hoof walls toward the coronet band. An example of one such boot design is shown in FIG. 35. As illustrated, this embodiment is consistent with the teachings of the invention, and may incorporate any of the designed described above, with the addition of a boot 900, which is preferably integral with the sides, heel and toe of the shoe, and extends directly upwardly from the shoe. The boot 900 is adapted for fitting around a hoof 910, thereby providing a friction fit and obviating the need for installation with nails. Nails, however, may be selectively included as needed to ensure a secure application. Holes 920 may be provided proximate to the opening of the boot to provide a manner for gripping the boot with fingers during installation. The boot may further comprise an additional opening to access nails, if used, for trimming

Turning from the construction of the horseshoe of the instant invention, a method and process of fitting the shoe will now be described, and will employ techniques and terminology well understood by those skilled in the farrier arts.

The first step is to prepare the hoof. In considering such preparation, regarding the trim and positioning of the horseshoe of the instant invention on a hoof, the trim required for the structurally supportive horseshoe is similar to the 4-point trim and the Natural Balance trim. In practice, after removing the shoe and nails, screws or glue already on the hoof, the farrier trims the hoof level from side to side (i.e., in the medial/lateral plane) as seen from holding the horse's leg just below the knee to allow the ligaments, tendons and muscles to settle into place, and level from toe to heel (anterior/posterior). It is highly preferable that the sole of the hoof is not cupped or cut out, but left a level plane surface except to relieve pressure if desired. In practice, if such sole relief is desired, it is suggested that no more than 1/16 of an inch is removed. Sole relief could be desirable around the tip of the coffin bone if the horse has a therapeutic condition related to rotation.

The toe is trimmed short so that, on the anterior/posterior plane, the distance from the edge of the toe to the widest part of the hoof is approximately ⅓ the distance from the widest part of the hoof to the back of the heel, while the bottom surface of the hoof is level parallel to the ground so that the coffin bone is parallel to the ground on a level surface or slightly tipped up, and the frog of the heel is trimmed back to healthy tissue.

From a side view, the slope or angle (or axis) of the front of the hoof wall should be at an angle similar to the natural angle of the horse's pastern down to the middle of the side view of the hoof, generally 45 to 60 degree angle depending on the horse's conformation. The trim should be such that the side axis along the top of the proximal phalanx to the middle phalanx and along the distal phalanx is a straight line, as opposed to a broken axis caused by too long a toe.

Finally, if a short toe model horseshoe constructed in accordance with the instant invention is being applied to the hoof, then once the horseshoe is in place on the hoof, the farrier can use a rasp to rocker the toe of the hoof upward, following the slope lines of the toe of the shoe, or in the alternative, the farrier can leave the toe as-is. The toe can be rockered across the front of the toe and may be squared off around the outer rim.

Once the hoof is trimmed, the next step is to prepare to affix the horseshoe to the hoof. This preparation involves a number of different steps, including:

Removing any debris, manure, rocks, etc. that may be caught along the bottom of the hoof;

Rasping the bottom of the hoof to make it level from side-to-side and front to back;

Using nippers to remove excess hoof wall and growth from the bottom of the hoof, similar to clipping fingernails in humans' hands;

Using a shoeing knife to remove any unnecessary tissue along the sides and base of the frog or bottom of the hoof, without cupping the sole of the hoof; and

Rasping the hoof walls to remove flares, notch to stop cracks, and generally clean up the hoof.

After the hoof is prepared, the next step is to determine the proper size and shape of shoe. As discussed in greater detail above, the supportive horseshoe of the instant invention may be fabricated in a number of different configurations, including that of an all-purpose shoe, a racing shoe, a shoe for therapeutic purposes, a boot, etc., and the farrier or veterinarian will choose the appropriate configuration, and determine which shoe size and which shoe width are appropriate, as a starting point, for each hoof.

The actual fitting process will take place once the appropriate shoe is chosen, and in a preferred process, will proceed as follows. First, assuming a shoe with a chevron heel, the shoe should be fit at the heel first, to make sure that the bottom of the chevron heel angle, at the point which touches the ground, is in vertical alignment with the heel bulbs of the horse's hoof, so that if an imaginary vertical line is drawn from that point of the chevron heel angle, the line will run along the outside of the axis of the heel bulbs. The remaining area of the shoe heel past the angle point of the chevron is designed to extend behind the hoof for support. In the alternative, if a square heel design is chosen, then the heel must extend at least to the vertical axis of the heel bulbs and preferably beyond, so that the heel bulbs do not protrude beyond the vertical axis of the end of the square heel, and the farrier will have enough material shape the end of the square heel for that particular hoof. The shoe can also be fitted to the hoof by placing the shoe's breakover at the tip of the coffin bone and making sure that the bottom angle of the chevron heel or square heel rests in alignment with the bulbs of the heel as if a vertical axis were drawn between the two points. The rest of the shoe's heel will extend beyond the hoof heel. It is important to note that in selecting the correct size and width of the horseshoe for each hoof, the farrier or veterinarian will allow for adequate surface area across the heel of the shoe to allow for full support of the heel of the hoof as it expands and contracts upon impact, and the shoe must at least be wide enough to extend between the walls of the foot from side to side at the widest part of the hoof.

It is another requirement that the shoe's breakover must fall underneath the tip of the coffin bone for correct placement. When properly fit, the breakover will be correctly located at the tip of the hoof's coffin bone or in close proximity, within, approximately, ¼ of the tip of the coffin bone.

Once the heel is fitted correctly, if the breakover is incorrectly positioned, then a different shoe size should be selected to fit the hoof. If a larger shoe size is required to meet the heel and coffin bone tip requirements, size overage areas such as along the sides of the shoe can be trimmed to fit.

In addition, if the sides of the shoe are too wide for the hoof, an additional adjustment can be made by either:
1) Nailing the shoe on the hoof, using nippers to cut off the excess, then rasping the sides of the shoe, keeping the bell angle slope of the hoof along the sides of the shoe. If this technique is used, the nippers must be used so that the long side of the nippers faces the ground to retain the hoof angle or the rasp is used after the nippers to adjust the angle of the newly customized edges of the shoes, which could be desired to be perpendicular to the ground such as for an injured horse or a horse that is racing; or
2) Tracing the edges of the hoof onto the shoe, then using nippers or a device like a jig saw to cut the excess edges off, then nailing the shoe onto the hoof, followed by rasping the edges to the outside angled slope of the hoof.

The hoof shape and sides can be traced onto the shoe or template by using a marker pen. The shoe can then be adjusted for the hoof by using a rasp, nippers, a jigsaw or similar mechanical or electrical devises that can cut through or remove the shoe materials. Once the sides of the shoe are modified to fit the shape of the hoof, the edges should be rasped to make them smooth and contoured at an angle that follows the slope of the sides of the hoof to the ground so as to extend the surface and side angles of the hoof or they may purposefully be angled perpendicular to the ground or angled anywhere in between as desired by the farrier or veterinarian.

If employing a short toe embodiment of the instant invention, the horse's toe may extend beyond the toe of the horseshoe, whereas when employing an all-purpose horseshoe or racing shoe, the toe of the shoe will extend to the end of the hoof toe. If desired, the tip of the toes of the shoe can be cut off to allow the hoof toe to extend over the shoe. This can be done with a rasp, nippers, jigsaw or similar implement that can cut through or remove the plastic materials.

Once sized, the inventive horseshoe can be affixed to the hoof by using either traditional horseshoe nails, by gluing the shoe onto the hoof or by using a drill and screwing the shoe onto the hoof. If glue is preferred, then a standard commercial glue designed for plastic horseshoes should be used, along with the other commercial products recommended as part of the gluing process by the manufacturer, such as denatured alcohol, and the glue should be placed only on the outer edges of the shoe where the hoof walls are located, and no glue is placed on or down the middle of the horseshoe, anterior to posterior or over the coffin bone, tip of the coffin bone area of the bottom of the hoof. Screws may be preferable in certain therapeutic conditions such as severe founder, where the pounding of nails into the foot is intolerable to the horse and glue may not affix as well.

Since it is preferable to use horseshoe nails, when using nails, for all optically transparent horseshoes, the farrier or veterinarian will place the shoe correctly on the hoof and then use a marker pen on the shoe to indicate where the nail holes are to be made. This can be done simultaneously with marking the hoof shape and sides onto the shoe for a custom fit. If using a marker pen to mark the sides of the hoof, then care should be taken to point the pen outward when tracing the hoof, not toward the hoof, so as not to make the sides too narrow.

As noted earlier, it is an advantage of the invention to form the components from an optically transparent material. This see-through characteristic of the horseshoe material and of the horseshoe template accessory material allows the farrier or veterinarian to see the white line around the bottom of the hoof, the apex of the frog and the location of the tip of the coffin bone; the entire bottom of the hoof.

Once positioned, horseshoe nail holes are punched or drilled through the horseshoe. This can be done using a drill press or a hand drill, however, such a method does not allow the farrier the ability to angle the horseshoe nail as required for the hoof. The optimum method for maximum control of the horseshoe nail is to use a countersink drill to make the nail holes in the shoe. The farrier uses a counter sink drill to make the nail holes through all surfaces of the inventive horseshoe, including the top, bottom and middle layer or Insert material of the shoe. Using a countersink drill allows the horseshoe nail head to be sunk up against the polycarbonate insert and to be surrounded by the outside urethane surface on the bottom of the shoe. In this way the horseshoe nail heads do not protrude beyond the surface of the ground side of the shoe, thereby preventing the horse from “walking on nails.”

In practice nail holes can be placed wherever the farrier or veterinarian wish to place them according to the shape and condition of each hoof. Farriers are generally taught not to place horseshoe nails behind the widest part of the hoof, however, it is acceptable to place horseshoe nails slightly behind the widest part of the foot for this invention to provide additional support to the extended heel of the shoe but not so far it the nails interfere with the frog/heel expansion during movement.

While the above process is useful with an optically transparent shoe, when using a colored or optically opaque or translucent horseshoe, the farrier or veterinarian will use a template accessory, which is the same size and has the same outer and inner dimensions as the colored shoe, and which replicates the shoe's shape across the ground facing surface, including the size and position of the apertures and the location of the breakover, but which doesn't need to be as thick as the actual shoe. The farrier will mark where the nail holes are to be placed and will validate that the location of the breakover is correctly positioned over the tip of the coffin by lining up the indicator line or mark on the template with the tip of the coffin bone. The farrier will then place the template accessory over the same size horseshoe and use the counter sink drill to make the nail holes through all surfaces of the colored horseshoe.

It is noted that while the farrier or veterinarian will modify the shape of the horseshoe as needed, minimal change should be made to the chevron angle underneath the heel of the hoof, although the square heel model can be custom shaped by the farrier or veterinarian for each horse as desired. In additional installation notes, it is recommended that the shoe should be affixed to the hoof using standard horseshoe nails, strong and long enough to keep the weight of the horseshoe affixed to the hoof during motion. It is also noted that when using a short toe variation of the horseshoe of the instant invention, it may be desirable to rocker the toes of each hoof with a rasp and/or square the toes of the hooves with a rasp once the shoe has been nailed to the hoof. It is further noted that when using the racing model, the front grab can be snipped off the bottom of the shoe or snipped shorter if desired using nippers, a rasp or other mechanical device that can cut through the materials or a combination of those devices. It is additionally noted that while the invention is described, in detail, with respect to a horse, the invention may also be used in connection with other animals that are shod in a similar fashion.

Finally, it is acknowledged that those who work with horses have tools and techniques that they use on a regular basis, and many of these can be used in conjunction with the instant invention. For example, Equithane® or similar commercial products can be applied to the hoof after the shoe has been affixed to the hoof if using a shoe model where the apertures pass completely through the shoe. Equithane is used to provide added support in cases such as rotted hoof frog, to create positive frog pressure, when the horse's sole needs additional support or if it is desired to seal off debris, rocks and foreign materials from wedging between the shoe surface and the bottom of the hoof surface. Equithane can be applied according to the commercial directions to the bottom of the hoof, in between the hoof and surface of the shoe as in the case of the rotted frog, with or without netting to help it affix better. Equithane is applied in the cutout areas of the inventive horseshoe and can be applied from the back or heel of the shoe for the frog. 2-ply silicon can also be applied to the bottom of the hoof to reside between the hoof and the shoe in order to achieve similar results.

Accordingly, by practicing the teachings of the invention a structurally supportive horseshoe is provided comprised of at least two portions, an outer shoe portion and an inner structural stabilizer portion, where the outer shoe portion being formed from a material that is softer than the structural stabilizer portion, and where the outer shoe portion, one side of which is fitted adjacent to the horse's hoof, and the other side of which comes into contact with the ground, is injection molded from a softer thermoplastic such as polyurethane, which is more insulating than the metal used in a traditional shoe, and thereby helps to maintain the natural temperature of the hoof, while acting as a shock absorber and providing a soft surface upon which the hoof can rest, while the structural stabilizer portion is formed from a harder thermoplastic, such as a polycarbonate, and is designed to support each of the elements of the arch of the foot while stabilizing the hoof on the ground and in motion, side-to-side, as well as when in the air.

As will be appreciated by those skilled in the art, the structurally supportive horseshoe of the instant invention comprises a design that may be tailored and adapted for distinct uses; everyday use, performance use, racing use and therapeutic use. The basic horseshoe design can also be adapted to a boot, and a template accessory to aid in affixing the invention if desired. In addition, each variation of the invention can be made available in a multiplicity of sizes to match the hoof size of the animal to be shod, and each model may be made with either an angled toe area or radius toe area, as well as with a square heel or chevron heel and in an oval or round shape.

The above disclosure is presented as being sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Further, it will be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

Finally, it is also to be understood that the following claims are intended to cover all of the generic and specific features of the invention herein described and all statements of the scope of the invention, which, as a matter of language, might be said to fall there between.

What is claimed is:

1. A structurally supportive horseshoe comprising:
an outer shoe member and a structural support member;
said outer shoe member comprising a contour having a configuration that approximates the bottom of a horse's hoof and further comprising at least a front edge, a rear edge, a first side edge and a second side edge;
said outer shoe member additionally comprising a ground-facing surface, a hoof-facing surface, a toe region, a heel region, and a central region, said ground-facing surface and hoof-facing surface being substantially parallel to each other over a portion of each of said ground-facing surface and said hoof-facing surface and being separated by a distance defining a thickness of said horseshoe;
said outer shoe member being formed from a first material and said structural support member being formed from a second material, said first material being softer than said second material;
said outer shoe member substantially encasing said structural support member; and
said structural support member comprising a configuration such that when structural support member is substantially encased within said outer shoe member and said structurally supportive horseshoe is fitted to a horse, said structural support member will at least partially support an area between said first side edge and said second side edge, across the width of a horse's foot underneath the coffin bone and an area around the sides of the horse's foot underneath the walls of the hoof, and will further support an area along the length of a horse's foot said length extending from a point behind the tip of the coffin bone and down at least the center of said foot to a point in alignment with, and an area beneath the vertical axis of the heel bulb and sideways underneath the heel and frog of the hoof.

2. The structurally supportive horseshoe, as claimed in claim 1, wherein at least a portion of the ground-facing surface of said outer shoe member comprises a tread to assist in traction.

3. The structurally supportive horseshoe, as claimed in claim 1, wherein said horseshoe further comprises a breakover region, said breakover region extending from said first side edge to said second side edge and being located at a point proximately coaxial with the tip of the coffin bone of the horse's hoof when the structurally supportive horseshoe is fitted; and wherein said ground-facing surface further comprises an incline proximate said toe region and extending from an area proximate said breakover region to said front edge, said incline oriented such that the distance between said ground-facing surface and said hoof-facing is greater proximate said breakover region than proximate said front edge.

4. The structurally supportive horseshoe, as claimed in claim 3, wherein said incline is linear.

5. The structurally supportive horseshoe, as claimed in claim 3, wherein said incline is curved.

6. The structurally supportive horseshoe, as claimed in claim 1, wherein said heel region is substantially formed in the shape of a chevron.

7. The structurally supportive horseshoe, as claimed in claim 1, wherein said horseshoe further comprises a plurality of apertures, said apertures passing through the ground-facing surface of said outer shoe member and said structural support member, without interrupting the portion of said structural support member supporting the area along the length of the horse's foot, said apertures comprises a plurality of edges and being oriented parallel to the length of said horseshoe, said edges resisting sliding of said horseshoe from side to side.

8. The structurally supportive horseshoe, as claimed in claim 7, wherein at least one of said apertures further pass through said hoof-facing surface, facilitating access to the hoof after the shoe has been shod.

9. The structurally supportive horseshoe, as claimed in claim 1, wherein said outer shoe member is formed from polyurethane.

10. The structurally supportive horseshoe, as claimed in claim 1, wherein said structural support member is formed from a polycarbonate.

11. The structurally supportive horseshoe, as claimed in claim 1, wherein said outer shoe member and said structural support member are formed from an optically transparent material.

12. The structurally supportive horseshoe, as claimed in claim 1, wherein said horseshoe is optically opaque, said horseshoe further comprising a template member, said template member being formed from an optically transparent material, and said template being formed with the same contour as said outer shoe member.

13. The structurally supportive horseshoe, as claimed in claim 2, wherein said ground-facing surface further comprises a grab positioned proximate the front edge of said horseshoe, said grab being integral with said structural support member and extending from said structural support member and through said ground-facing surface.

14. The structurally supportive horseshoe, as claimed in claim 2, wherein at least a portion of said tread further comprises studs.

15. The structurally supportive horseshoe, as claimed in claim 1, wherein the contour defined by said outer shoe member is adapted such that when fitted to a horse, at least a portion of said horse's toe will extend beyond the contour defined by the structurally supportive horseshoe.

16. The structurally supportive horseshoe, as claimed in claim 8, wherein said hoof-facing surface of said outer shoe member comprises a channel, said channel being cooperative with said aperture such that access to the sole of said hoof may be had after the shoe has been shod.

17. The structurally supportive horseshoe, as claimed in claim 1, further comprising a boot member, said boot member cooperative with said front edge, said rear edge, said first side edge and said second side edge, said boot member extending up at least a portion of a horse's hoof or leg.

18. The structurally supportive horseshoe, as claimed in claim 1, wherein said horseshoe is manufactured through a molding process wherein said structural support member is fabricated from a first material and said outer shoe member is fabricated from a second material and is molded around substantially all of said structural support member, substantially encasing said structural support member within said outer shoe member.

19. A method for fitting a structurally supportive horseshoe, comprising:
preparing the hoof to remove any old horseshoe, nails, screws and glue;
trimming the hoof level from toe to heel and from side to side;
cleaning the hoof of any debris;
rasping the hoof to make it level from side to side;
removing the excess hoof wall and growth from the bottom of the hoof;
removing unnecessary tissue along the side and base of the frog;
rasping the hoof walls to remove flairs;
determining the shape and size of a structurally supportive horseshoe in order to provide a custom fit for a particular application;
choosing a structurally supportive horseshoe based on said determination of shape and size, said horseshoe comprising an outer shoe member and a structural support member; said outer shoe member comprising a ground-facing surface, a hoof-facing surface, a toe region, a heel region, and a central region; said ground-facing surface comprising a breakover; said outer shoe member being formed from a first material and said structural support member being formed from a second material, said first material being softer than said second material; said outer shoe member substantially encasing said structural support member; and said structural support member comprising a configuration such that when structural support member is substantially encased within said outer shoe member and said structurally supportive horseshoe is fitted to a hoof, said structural support member will at least partially support an area between said first side edge and said second side edge, across the width of a horse's foot at a point behind the tip of the coffin bone and an area around the sides of the horse's foot underneath the walls of the hoof, and will further support an area along the length of a horse's foot said length extending from a point behind the tip of the coffin bone and down at least the center of said foot to a point in alignment with, and an area beneath the vertical axis of the heel bulb and sideways underneath the heel and frog of the hoof;
fitting the chosen horseshoe starting at the heel, ensuring that the heel region extends to cover at least the heel bulbs and further ensuring that the breakover of the shoe will be positioned proximate the tip of the coffin bone;
adjusting the shoe to remove excess material; and
affixing the shoe to the hoof.

20. The method for fitting a structurally supportive horseshoe, as claimed in claim 19, wherein said structurally supportive horseshoe further comprises a template member, said template member being formed from an optically transparent material, and said template being formed with the same contour as said outer shoe member, said step of fitting the chosen horseshoe at the heel begin replaced with fitting the template member at the heel, with the additional step of marking said template member where nail holes should be placed and then placing said marked template member over said structurally supportive horseshoe and drilling holes in said horseshoe in accordance with said markings.
